(19) United States
(12) Patent Application Publication
(10) Pub. No.: US 2010/0014669 A1
(43) Pub. Date: Jan. 21, 2010

(54) Codec-independent encryption of material that represents stimuli intended for human perception

(76) Inventor: Wenyu Jiang, San Francisco, CA (US)

Correspondence Address: Dolby Laboratories Inc., 999 Brannan Street, San Francisco, CA, 94103, US

(21) Appl. No.: 12/309,342

(22) PCT Filed: Jul. 13, 2007
(86) PCT No.: PCT/US2007/015988

§ 371 Date: Sep. 2, 2009

Related U.S. Application Data
(60) Provisional application No. 60/830,774, filed on Jul. 13, 2006.

(51) Int. Cl. H04L 9/00; H04N 7/167

(52) U.S. Cl. 380/255; 380/239

(57) ABSTRACT

Processors that encrypt frames of data representing images and sounds, for example, use a first encryption process to encrypt control data that includes selected data from the data frames and use a second encryption process to encrypt non-selected data from the data frames. The first encryption process is responsive to a key, which may be associated with an intended recipient of the data frames. The second encryption process is responsive to a key that is obtained or derived from the control data. The encrypted control data and the encrypted non-selected data may be delivered to a receiver using separate media. The receiver recovers the data frames using decryption processes that are inverse to the first and second encryption processes. Efficient implementations of the second encryption process are disclosed.

### TECHNICAL FIELD

The present invention pertains generally to encryption and pertains more specifically to the encryption of material that represents stimuli intended for human perception such as still and moving visual images and sounds.

### BACKGROUND ART

Multimedia entertainment content and other material that represents stimuli intended for human perception is being delivered to consumers in digital formats through a variety of distribution media including the internet. The use of digital formats has facilitated distribution of this material on one hand but it has also facilitated unauthorized copying and presentation of the material on the other hand.

A variety of methods generally referred to as Digital Rights Management (DRM) have been developed and are being developed to help protect against the unauthorized use of material that is afforded copyright protection. Common DRM methods encrypt some or all of the material and allow this material to be distributed freely but control the distribution of a means to decrypt the encrypted information to only those individuals who have obtained a right to use the material. The means to decrypt the encrypted information generally fall into one of two approaches.

The first DRM approach uses encryption and decryption based on a material-oriented cipher key that is associated with the material. The material-oriented key needed for decryption is unique to that material and is distributed to all authorized recipients in some secure and controlled manner. One example of this approach is implemented in versions of the Windows Media player software available from Microsoft Corporation, Redmond, Wash., and is referred to as Windows Media DRM. This particular implementation gives each authorized recipient a content certificate or digital file that is unique to that recipient. The content certificate contains a material-oriented key that has been encrypted using encryption that is based on some recipient-oriented master key that is unique to the recipient.

The second DRM approach uses encryption and decryption based on a recipient-oriented cipher key that is associated with an intended recipient of the material. The recipient-oriented key needed for decryption is unique to that recipient and may differ for different materials. One example of this approach is implemented in the iTunes service provided by Apple Computer, Inc., Cupertino, Calif., and is referred to as FairPlay DRM. This particular implementation gives each authorized recipient a recipient-oriented key that is encrypted using encryption based on a recipient-oriented master key.

For either approach, the recipient generally has only one master key. Each approach has advantages relative to the other. The first material-oriented approach can be more efficient but it can also be less secure. Computer systems that act as distribution servers for the first material-oriented approach generally require fewer computational resources because the material can be encrypted once for all authorized recipients. Unfortunately, the security of all distributions of the material can be compromised if the one material-oriented key is made available to the public through crypto analysis or unauthorized disclosure.

For either approach, however, symmetric-key or secret-key encryption methods are often used when all of the material is encrypted because the computational resources needed to perform more secure methods such as asymmetric-key or public-/private-key methods are usually prohibitively expensive. Efficiency can be increased without sacrificing security by applying a higher-security encryption process to a selected portion of the material and either applying a lower-security encryption process or using no encryption for the remainder of the material. The selected portion preferably is chosen such that the remainder of the material has essentially no value without the selected portion.

Two basic approaches exist for choosing what selected portion is encrypted using higher-security encryption processes. The first approach is based on the logical structure of the material, which in turn depends on the encoding/decoding (codec) technology used to encode the material into a signal for transmission or storage and subsequently decode the signal for playback or presentation. This codec-dependent approach allows the selected portion to be chosen in such a way that security can be optimized for a given level of encryption efficiency but generally no single choice is acceptable for different types of material or for a given type of material that is encoded by different encoding technologies. Codec-independent methods are preferable for wider ranges of usage.

### DISCLOSURE OF INVENTION

The objects of the present invention are to protect against the unauthorized copying and presentation of material that represents stimuli intended for human perception in a codec-independent way that provides for an improvement in processing efficiency without degrading the level of protection, that provides for an improvement in the level of protection without decreasing efficiency, or that provides for a balanced improvement in both efficiency and security.

These objects are achieved by the present invention as set forth in the independent claims. Advantageous implementations are set forth in the dependent claims.

The various features of the present invention and preferred implementations may be better understood by referring to the following discussion and the accompanying drawings in which like reference numerals refer to like elements in the several figures. The contents of the following discussion and the drawings are set forth as examples only and should not be understood to represent limitations upon the scope of the present invention.

### BRIEF DESCRIPTION OF DRAWINGS

FIGS. 1 and 2 are schematic block diagrams of systems in which processors prepare encrypted material for transmission or storage for subsequent delivery to a receiver.

FIG. 3 is a schematic block diagram of a network of processors and receivers.

FIGS. 4 and 5 are schematic block diagrams of processors that prepare encrypted material for transmission or storage for subsequent delivery to a receiver.

FIGS. 6 and 7 are schematic block diagrams of receivers that receive encrypted material to be decrypted and presented to a recipient.

FIG. 8 is a schematic block diagram of a device that may be used to implement various aspects of the present invention.

### MODES FOR CARRYING OUT THE INVENTION

### A. Introduction

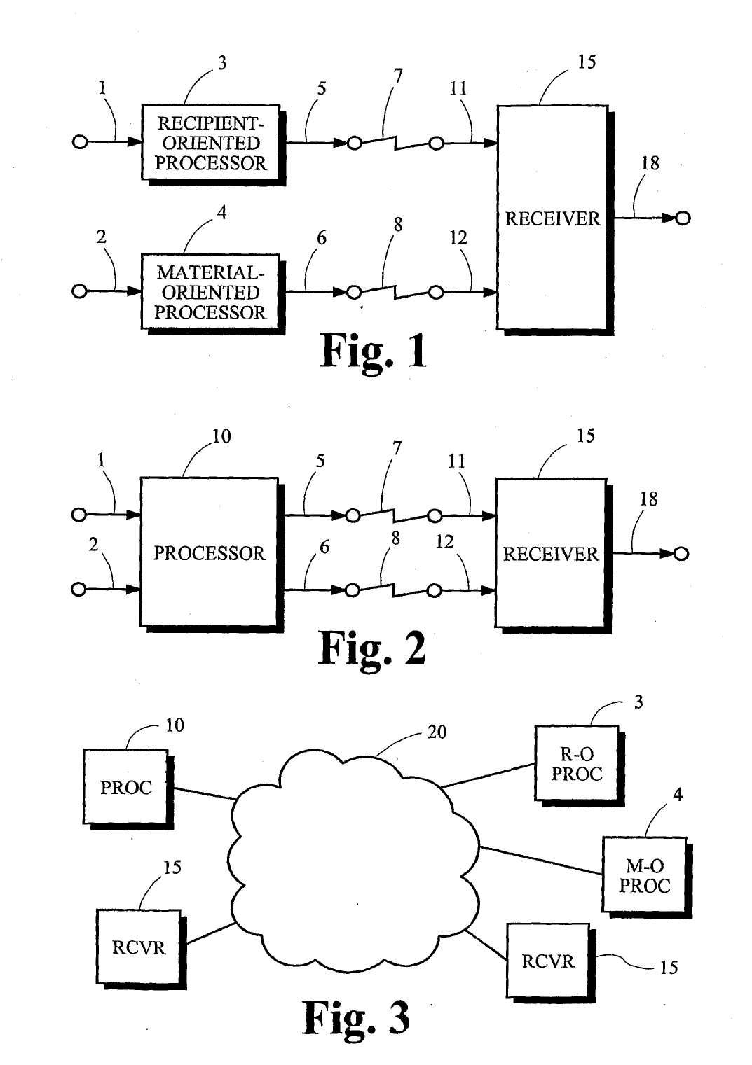

FIGS. 1 and 2 are schematic block diagrams of systems that generate encrypted representations of specified material that represents stimuli intended for human perception such as still or moving images and sounds. The encoded representations are distributed to receivers for decryption and presentation to an intended recipient. Throughout this disclosure, more particular mention is made of material that is represented by data arranged in one or more frames. The term “frame” refers to any division or segmentation of data that may be desired. In this context, the frame referred to herein need not correspond to divisions of the data that are pertinent to any encoding technology used to encode the material for transmission or storage. Data representing a single image may be organized into one frame. Data representing the images in a motion picture, for example, are typically organized into a sequence of frames.

Referring to FIG. 1, the processor 3 receives one or more signals from the path 1 that convey an indication of the specified material, obtains control data including selected data representing a portion of the specified material, applies a first encryption process to the control data to generate first encrypted data, and assembles the first encrypted data into a first encoded signal that is passed along the path 5. The first encryption process is responsive to a first encryption key and the control data represents or corresponds in some manner to a second encryption key.

The processor 4 receives one or more signals from the path 2 that convey the frame of data, obtains non-selected data in the frame of data that is not included in the selected data, applies a second encryption process to the non-selected data to generate second encrypted data, and assembles the second encrypted data into a second encoded signal that is passed along the path 6. The second encryption process is responsive to the second encryption key.

The encoded signals passed along the paths 5 and 6 are delivered to the distribution media 7 and 8, respectively, which may be electrical, optical or wireless transmission media for baseband or modulated communication signals throughout the spectrum including from supersonic to ultraviolet frequencies, or a storage media using essentially any recording technology including magnetic tape, cards or disk, optical cards or disc, and detectable markings on media including paper. The distribution media 7 and 8 deliver the first and second encoded signal to the paths 11 and 12, respectively.

The receiver 15 receives the first and second encoded signals from the paths 11 and 12, respectively. The receiver 15 applies a first decryption process to the first encrypted data to obtain control data including selected data in a frame of data of the specified material. The first decryption process is responsive to a first decryption key and the control data includes information from which a second decryption key may be obtained or derived. The receiver 15 applies a second decryption process to the second encrypted data to obtain non-selected data. The second decryption process is responsive to the second decryption key. The selected data is combined with the non-selected data into a frame of data representing the specified material that represents stimuli intended for human perception.

The selected data and the non-selected data each includes at least some of the data representing the specified material in the frame of data; however, the selected data and the non-selected data collectively need not constitute all of the data representing the specified material in the frame of data. Other data in a frame may be distributed to the receiver 15 in a form that is not encrypted by either the first encryption process or the second encryption process. This other data is referred to herein as “plaintext data” because it can be distributed to the receiver 15 without encryption; however, this so-called plaintext data can be encrypted or scrambled by some other process if desired.

In a preferred implementation, the first encryption key and the first decryption key are associated with the intended recipient and the first encryption process and the first decryption process are designed such that it is infeasible for anyone other than the intended recipient to decrypt the first encrypted data, thereby making the processor 3 a recipient-oriented processor as labeled in the drawing. Preferably, the second encryption key and second decryption key are associated with the specified material and the second encryption process and second decryption process are designed such that it is infeasible for anyone without the second encryption key to decrypt the second encrypted data, thereby making the processor 4 a material-oriented processor as labeled in the drawing.

The system shown in FIG. 2 is similar to the system shown in FIG. 1 but differs in that the processor 10 performs the operations performed by the processors 3 and 4.

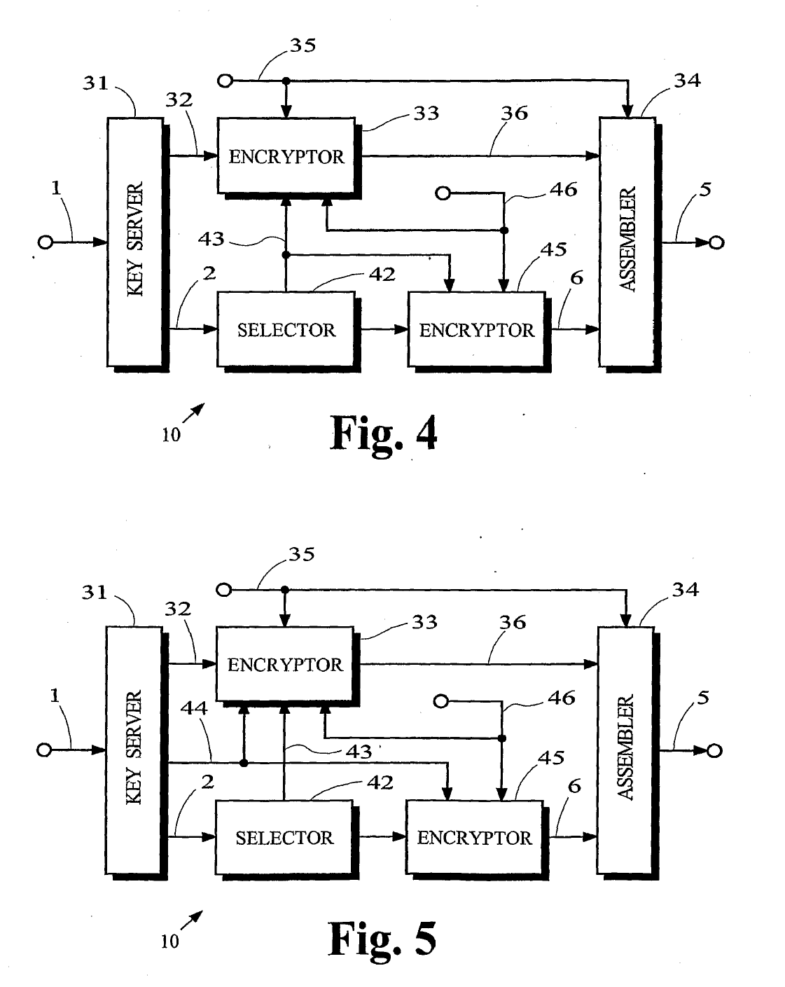

FIG. 3 is a schematic block diagram of a network of processors and receivers as illustrated in FIGS. 1 and 2 and as described above. The distribution facility 20 represents an implementation of the distribution media 7 and 8. For example, the distribution facility 20 may be a wide-area network, a local-area network, a conveyance of physical storage media, or a combination of networks and conveyances.

The operations that are described for the processor 3 and the processor 4 may be performed concurrently or at different times. The first encrypted data may be generated before, after or concurrently with the generation of the second encrypted data. The first encoded signal may be distributed before, after or concurrent with the distribution of the second encoded signal. The processes may be allocated to different computer systems according to available processing resources. For motion pictures, for example, the second encrypted data can be generated once for all recipients and recorded on one or more storage media for immediate or subsequent distribution to intended recipients. A unique set of first encrypted data can be generated and distributed on demand at a later time for each intended recipient.

In systems for encryption and distribution of specified material for motion pictures, for example, the bandwidth or storage capacity required to convey the second encoded signal is typically much larger than that required to convey the first encoded signal. For systems such as these, it may be preferable to use different types of distribution media for the two encoded signals. For example, the first encoded signal may be distributed by a transmission medium and the second encoded signal may be distributed by physical delivery of a storage medium. Alternatively, the first encoded signal may be distributed by a wireless transmission medium and the second encoded signal may be distributed by an electrical or optical transmission medium. The second encoded data may also be distributed on a peer-to-peer network if desired, which may reduce the cost of distribution. Any plaintext data can be distributed in essentially any manner that may be desired including a distribution with the second encrypted data.

### B. Transmitter

FIGS. 4 and 5 are schematic block diagrams of implementations for the processor 10. Features of these implementations are applicable to the processors 3 and 4.

Referring to FIG. 4, the key server 31 receives one or more signals from the path 1 that convey an indication of the specified material. Either this indication of the specified material or a frame of data of the specified material is passed along the path 2 to the selector 42. The frame of data that is passed along the path 2 may be stored and directly accessible by the key server 31 or it may be obtained from a source not shown in the figure in response to the indication of the specified material. The selector 42 obtains the frame of data, selects a portion of it, and passes the selected data along the path 43 to the encryptor 33. The selected data may be combined with other data if desired and constitutes control data. The encryptor 33 applies a first encryption process to the control data to generate first encrypted data along the path 36. The first encryption process is responsive to a first encryption key that is provided by the key server 31 through the path 32. If desired, the first encryption process may also be responsive to a first initialization vector (IV) received from the path 35. If desired, the first IV may be provided by the key server 31. The use of a first IV is optional but, if one is used, preferably it is encrypted in some manner not shown in the figure.

At least a portion of the selected data, which represents a second encryption key, is passed along the path 43 to the encryptor 45. The encryptor 45 applies a second encryption process to non-selected data in the frame of data to generate second encrypted data along the path 6. The non-selected data represents at least a portion of the data in the frame of data that is not included in the selected data. The second encryption process is responsive to the second encryption key and may also be responsive to a second IV received from the path 46. If desired, the second IV may be provided by the key server 31. The use of a second IV is optional but, if it is used, it is passed to the encryptor 33 and combined into the control data with the selected data.

The assembler 34 assembles the first encrypted data and any first IV that may have been used into an encoded output signal that is passed along the path 5. The second encrypted data may also be assembled into the output signal as shown in the figure. In implementations that encrypt and distribute material representing motion pictures, for example, the first and second encrypted data may be assembled into different output signals for delivery by different distribution media as described above and as illustrated in FIGS. 1 and 2.

The implementation of the processor 10 that is shown in FIG. 5 is similar to the implementation shown in FIG. 4 but differs in that the encryptor 45 applies a second encryption process that is responsive to a second encryption key that is not represented by the selected data but is received from the key server 31 through the path 44. This second encryption key is passed to the encryptor 32 and combined into the control data with the selected data.

### C. Receiver

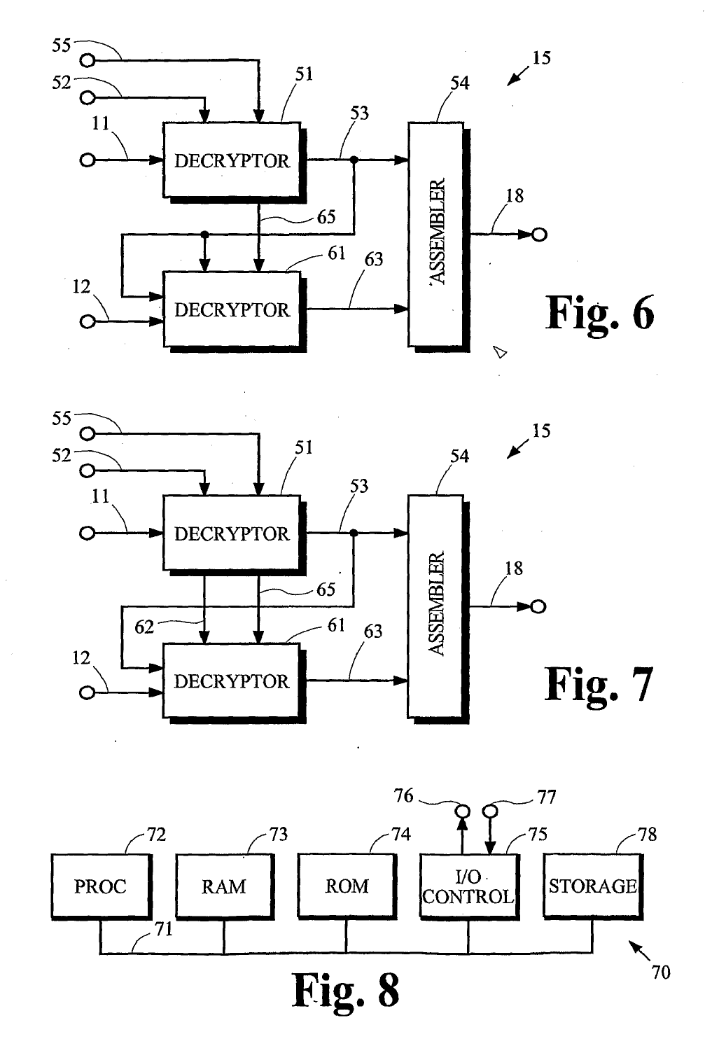

FIGS. 6 and 7 are schematic block diagrams of implementations for the receiver 15. The receiver 15 illustrated in FIG. 6 may be used advantageously to receive and decrypt signals generated by the processor 10 illustrated in FIG. 4. The receiver 15 illustrated in FIG. 7 may be used advantageously to receive and decrypt signals generated by the processor 10 illustrated in FIG. 5.

Referring to FIG. 6, the decryptor 51 receives first encrypted data from the path 11, receives a first decryption key from the path 52, and applies a first decryption process to the first encrypted data to generate control data along the path 53. The first decryption process is responsive to the first decryption key. The control data includes selected data in a frame of data of specified material that represents stimuli intended for human perception. The selected data represents information from which a second encryption key may be obtained or derived. The second decryption key is passed along the path 53 to the decryptor 61. The first decryption process may also be responsive to a first IV received from the path 55. The use of a first IV is optional in principle but should be used if the first encrypted data was generated by a complementary first encryption process in the processor 10 that used an IV. If the first IV is encrypted, it is decrypted in some manner not shown in the figure.

The encryptor 61 receives second encrypted data from the path 12, receives the second decryption key from the path 53, and applies a second decryption process to the second encrypted data to generate non-selected data along the path 63. The non-selected data represents at least a portion of the data in the frame of data that is not included in the selected data. The second decryption process is responsive to the second decryption key and may also be responsive to a second IV. If a second IV is used, it is obtained from the control data and passed along the path 65. The use of a second IV is optional in principle but should be used if the second encrypted data was generated by a complementary second encryption process in the processor 10 that used the second IV.

The assembler 54 assembles the selected data and the non-selected data into a frame of data representing the specified material. Other data such as plaintext data may also be combined with the selected data and the non-selected data into the frame of data.

The implementation of the receiver 15 that is shown in FIG. 7 is similar to the implementation shown in FIG. 6 but differs in that the decryptor 61 applies a second encryption process that is responsive to a second decryption key obtained or derived from information in the control data that is not represented by the selected data. The second decryption key is received from the path 62.

### D. Encryption Processes

### 1. Overview

The first and second encryption processes may be performed in a variety of ways. The two processes may be performed identically or in different ways. In implementations of systems for encryption of specified material for motion pictures, for example, a more efficient symmetric secret-key encryption method is used to perform the second encryption process and a less efficient asymmetric public-key/private-key encryption method is used to perform the first encryption process. A few examples of symmetric-key encryption methods include the Advanced Encryption Standard (AES) block cipher, variants of the Data Encryption Standard (DES), the International Data Encryption Algorithm (IDEA) proposed by Lai and Massey, and a cipher that is described below. A few examples of asymmetric-key encryption methods include the RSA cipher proposed by Rivest, Shamir and Adleman and the ElGamal cipher proposed by ElGamal. A wide variety of cipher-key distribution and exchange protocols may be used. Normal considerations may be taken into account to choose a suitable key distribution or exchange protocol.

In a preferred implementation, the first encryption key is the public key and the first decryption key is the private key of a public-key/private-key pair that are associated with an intended recipient of the specified material, and the second encryption key and second decryption key are symmetric keys that are associated with the specified material. One symmetric key may be used for all frames of the specified material or an instance of the symmetric key may be obtained from the data in each frame as discussed above and described below. In a preferred implementation, the first encryption/decryption processes and related keys are said to be recipient-oriented and the second encryption/decryption processes and related keys are said to be material-oriented. This is reflected in FIG. 1, which illustrates the processor 3 as a recipient-oriented processor and illustrates the processor 4 as a material-oriented processor.

Several methods that may be used to perform the second encryption process are described below.

### 2. Basic Implementation

The second encryption process may be implemented by essentially any invertible transform. One suitable type of transform can be expressed as:

Y=A·X (1)

where A=matrix of k rows and m columns;

X=non-selected data in the frame of data to be encrypted; and

Y=second encrypted data generated by the encryption process.

A complementary decryption process can be expressed as:

X=A⁻¹·Y (2)

where A⁻¹ is an inverse matrix of the matrix A.

A frame of data X to be encrypted is organized in rows and columns comprising k packets of a fixed length with m symbols or elements in a finite field. Each of the k packets is a row in the frame of data and each of the m symbols in a packet is in a respective column of the frame of data. The resulting encrypted data Y is a frame of data having k−1 rows and m columns as discussed below.

The following examples assume each symbol is one byte of data, where each byte contains eight bits. The specific length of the packets is not critical but preferably is chosen to be at least as long as the encryption key so that a brute-force crypto analysis attack on the first encrypted packet by random guessing the value of its bits is not easier than a brute-force random guessing of the key used to encrypt that packet.

One implementation of the transform shown in equation 1 may be expressed as:

y₀=x₀ (3)

yᵢ=a·xᵢ+b·yᵢ₋₁+c·xᵢ₋₁ for 1≦i<k

where x₀=row or packet 0 in a frame of data X;

xᵢ=row or packet i in a frame of data X;

yᵢ=row or packet i in a frame of encrypted data Y; and

a, b, c=non-zero matrix coefficients.

The values for these matrix coefficients as well as other matrix coefficients discussed below may be established in any way that may be desired but preferably are established by a process that generates pseudo-random values in response to at least part of the selected data for each frame of data to be encrypted. The values should be non-zero to ensure the encryption matrix A is invertible.

Expression 3 represents a transform that is referred to in the following discussion as the basic transform. The basic transform does not encrypt the first row or packet x₀ of data. This packet corresponds to the selected data within the control data discussed above, which is encrypted by the first encryption process.

In one implementation, each term in expression 3 is an 8-bit number that is defined in an 8-bit finite field. If desired, a longer finite field may be used, which would allow the matrix to be applied to data symbols that are longer than eight bits. The use of a finite field allows the transform to be implemented by arithmetic operations on data elements with a fixed number of bits (eight bits in this example) without having to worry about carry bits or arithmetic underflow and overflow. The arithmetic operations that are shown in expression 3 can be expressed for i=1, 2 as:

$$\begin{matrix}{y}_{0} = {x}_{0} & ( 4 ) \\ \begin{matrix}{y}_{1} = a \cdot {x}_{1} + b \cdot {y}_{0} + c \cdot {x}_{0} \\ = a \cdot {x}_{1} + ( b + c ) \cdot {x}_{0} \\ {y}_{2} = a \cdot {x}_{2} + b \cdot {y}_{1} + c \cdot {x}_{1} \\ = a \cdot {x}_{2} + c \cdot {x}_{1} + b \cdot ( a \cdot {x}_{1} + ( b + c ) \cdot {x}_{0} ) \\ = a \cdot {x}_{2} + ( b \cdot a + c ) \cdot {x}_{1} + b \cdot ( b + c ) \cdot {x}_{0}\end{matrix} & \end{matrix}$$

This expression is equivalent to the multiplication of a triangular matrix below the main diagonal of the matrix A as shown in equation 5.

$$\begin{matrix}[ \begin{matrix}{y}_{0} \\ {y}_{1} \\ {y}_{2} \\ {y}_{3} \\ … \\ {y}_{k - 1}\end{matrix} ] = Y \\ = A \cdot X \\ = [ \begin{matrix}1 & 0 & 0 & 0 & … & 0 \\ b + c & a & 0 & 0 & … & 0 \\ b \cdot ( b + c ) & b \cdot a + c & a & 0 & … & 0 \\ {b}^{2} \cdot ( b + c ) & b \cdot ( b \cdot a + c ) & b \cdot a + c & a & … & 0 \\ … & … & … & … & … & 0 \\ … & … & … & … & … & 0\end{matrix} ] \cdot [ \begin{matrix}{x}_{0} \\ {x}_{1} \\ {x}_{2} \\ {x}_{3} \\ … \\ {x}_{k - 1}\end{matrix} ]\end{matrix} \qquad ( 5 )$$

Equation 5 shows that expression 3 is merely a special case of the transform shown in equation 1. The equations in expression 3 are equivalent to a full-rank invertible matrix transformation provided the coefficients a, b, c are all non-zero. The transform in expression 3 is only one transform of many that satisfy the invertible property but it is attractive because it can be implemented by a 3-tap linear filter. The computational complexity of this transform is O(k) for each column, which is much lower than the computational complexity O(k²) of a transform that has non-zero coefficients throughout the matrix.

The encryption process implemented in expression 3 can be applied to rows or packets of data in a progressive or incremental manner. The entire frame of input data does not have to be available before the encryption process can begin. This allows a reduction in the amount of memory required to store data for encryption or a reduction in buffering delays. The same advantages apply to the complementary decryption process, which can be expressed as:

$${x}_{0} = {y}_{0} \\ \begin{matrix}a \cdot {x}_{i} = {y}_{i} - b \cdot {y}_{i - 1} - c \cdot {x}_{i - 1} ⇒ {x}_{i} \\ = \frac{( {y}_{i} - b \cdot {y}_{i - 1} - c \cdot {x}_{i - 1} )}{a} \cdot for 1 \leq i < k\end{matrix} \qquad ( 6 )$$

The equations in expression 6 show that the transform of expression 3 is invertible provided that the coefficient a has a non-zero value; however, it is important to ensure the coefficients b and c are also non-zero so that each decrypted packet depends on the content of the previous packet. This ensures an unauthorized recipient cannot decrypt a packet without decrypting all previous packets.

### 3. Alternative Implementations

An alternate basic transform and an alternate basic inverse transform that may be used to implement the second encryption process and its complementary second decryption process can be derived from the transforms shown in equations 1 and 2, respectively, by reversing the order of terms in the matrix multiply operations. These alternate transforms are not discussed here in detail. The details of their implementation may be obtained directly from the discussion of the basic transforms by reversing the order of terms in matrix multiplication operations, transposing matrices, swapping row and column vectors, and interchanging references to rows and columns.

Implementations of the basic transform discussed above and variations with additional features discussed below correspond to an arithmetic process that multiplies a matrix A of coefficients by a frame of the data X to be encrypted. An inspection of the equations shown in expression 3 reveals that the arithmetic operations for each column of the frame of data X or the frame of data Y are performed independently of the arithmetic operations for other columns. The level of security provided by the basic transform can be improved by using one or more features discussed below.

If the alternate basic transform mentioned above or a variation with additional features is used to implement the second encryption process, this implementation corresponds to an arithmetic process that multiplies a frame of the data X to be encrypted by a matrix A of coefficients. The arithmetic operations for each row of the frame of data X or the frame of data Y are performed independently of the arithmetic operations for other rows. The level of security provided by the alternate basic transform can be improved by using appropriate variations of one or more of the features discussed below that can be derived from the following discussion by interchanging references to rows and columns and making other changes as explained above.

An application of a transform is generally referred to in the following discussion in terms of matrix operations or various arithmetic operations with a matrix of coefficients arranged in rows and columns. These references are a convenient way to describe the alternative implementations and are not intended to imply any particular way in which this transform must be implemented. Other ways are possible such as by application of multi-tap filters as described above.

### a) Additional Features

One way in which alternative implementations may be realized is to incorporate additional features into the encryption process by performing various operations in addition to an application of the basic transform. These additional features may be used in combination with one another.

### (1) Column Permutations

The level of security provided by the basic transform may be increased by altering or permuting the order of the columns in the encryption transformation. This may be done in a variety of ways as explained below. The method or function used to derive the order may have practical significance in affecting the overall security of the encryption process but no particular method is essential in principle. Possible methods are described below.

### (a) Matrix Coefficients

One feature rearranges the columns of the transform matrix A before its application to the frame of data X to be encrypted. The m columns of the matrix may be arranged in any one of m! possible orders or permutations. The order is specified by at least part of the control data described above. In one implementation, the permutation order is derived from the first packet or row x₀ in the selected data from the frame of data as represented by the following equation:

A′[i,j]=A[i,F(x₀,j)] for 0≦i<k, 0≦j<m (7a)

where A[i,j]=coefficient of matrix A in row i and column j;

F (x₀,j)=permuted column number for column j; and

A′[i,j]=coefficient of matrix A with permuted columns.

According to this notation, F(x₀,j) represents the index number of the original column that is shifted into column j.

Column permutations may be row-dependent in that they may be allowed to vary from row to row of the matrix. This may be done in essentially any way that is dependent on row number. One way achieves this result by invoking the permutation function F a different number of times for each row. Each subsequent invocation of the permutation function performs its permutation process on the permuted result obtained by the previous invocation. In one example, the permutation function is invoked a number of times equal to the row number, which can be represented as:

A′[i,j]=A[i,Fⁱ(x₀,j)] for 0≦i<k, 0≦j<k (7b)

### (b) Data Packets

Another feature rearranges columns of data either before or after application of the transform matrix to the data to be encrypted. When used with the basic transform of expression 3 described above, the same result may be achieved either by rearranging columns of the non-selected data X prior to application of the basic transform or by rearranging columns of the encrypted data Y after application of the basic transform.

The m columns of data may be arranged in any one of m! possible orders or permutations. The order is specified by at least part of the control data described above. In one implementation of column permutation for a frame of data X, for example, the permutation order is derived from the first packet or row x₀ in the selected data from the frame of data as represented by the following equation:

X′[i,j]=X[i,F(x₀,j)] for 1≦k, 0≦j<m (8a)

where X[i,j]=byte j of data in row i of a frame of data X;

F(x₀,j)=permuted column number for column j; and

X′[i,j]=byte j of data in row i of a frame of data X after permutation.

Column permutations may be row-dependent in that they may be allowed to vary from row to row. This may be done in essentially any way that is dependent on row number. One way achieves this result by invoking the permutation function F a different number of times for each row. Each subsequent invocation of the permutation function performs its permutation process on the permuted result obtained by the previous invocation. In one example for the data X to be encrypted, the permutation function is invoked a number of times equal to the row number, which can be represented as:

X′[i,j]=X[i,Fⁱ(x₀,j)] for 1≦i<k, 0≦j<m (8b)

### (2) Row Permutations

The level of security provided by the basic transform may be increased by altering or permuting the order of the rows in the encryption transformation. This may be done in a variety of ways as explained below. The method or function used to derive the order may have practical significance in affecting the overall security of the encryption process but no particular method is essential in principle. Possible methods are described below.

### (a) Data Packets to be Encrypted

One feature rearranges the rows of data in the frame of data X prior to application of the transform matrix. Preferably, the first row is not shifted. Row permutation of the data to be encrypted may be expressed as:

X′[i,j]=X[G(x₀,i),j] for 1≦i<k, 0≦j<m (9)

where X′[i,j]=byte j of data in row i of a frame of data X after permutation; and

G(x₀,i)=permuted row number for row i.

According to this notation, G(x₀,i) represents the index number of the original row that is shifted into row i.

Row permutations may be column dependent in that they may be allowed to vary from column to column. This may be done in essentially any way that is dependent on column number. One way achieves this result by invoking the permutation function G a different number of times for each column. Each subsequent invocation of the permutation function performs its permutation process on the permuted result obtained by the previous invocation. In one example, the permutation function is invoked a number of times equal to one plus the column number, which can be represented as:

X′[i,j]=X[G^{j+1}(x₀,i),j] for 1≦i<k, 0≦j<m (10)

### (b) Packets of Encrypted Data

Another feature rearranges the order of rows of the encrypted data. This may be achieved either by permuting rows of the transform matrix A or by permuting rows of encrypted data in a frame of encrypted data Y after application of the transform matrix. A permutation of rows in the transform matrix may be expressed as:

A′[i,j]=A[G(x₀,i),j] for 1≦i<k, 0≦j<m (11a)

where A′[i,j]=coefficient of matrix A in row i and column j after permutation; and

G(x₀,i)=permuted row number for row i.

The permutation of rows of the encrypted data Y may be expressed as:

Y′[i,j]=Y[G(x₀,i),j] for 1≦i<k, 0≦j<m (11b)

where Y′[i,j]=encrypted data in row i and column j after permutation.

Row permutations may be allowed to vary from column to column, which may be done in essentially any way that is dependent on column number. One way is described above in connection with equation 10. This method of row permutation for the transform matrix A and the encrypted data Y can be represented as:

A′[i,j]=A[G^{j+1}(x₀,i),j] for 1≦i<k, 0≦j<m (12a)

Y′[i,j]=Y[G^{j+1}(x₀,i),j] for 1≦i<k, 0≦j<m (12b)

### (3) Column and Row Permutations

Another feature uses one or more types of row and column permutations. If desired, rows and/or columns can be permuted before and after application of the transform matrix. Furthermore, any combination of row-dependent and row-independent column permutation can be used with column-dependent and column-independent row permutation but the order in which the permutations are done is important. During decryption, the complementary inverse permutations are performed in reverse order.

### (4) One-Dimensional Dynamic Coefficients

Another feature modifies the coefficients a, b and c of the basic transform matrix A so that a different set of coefficients is used for each row. With this feature, the equations shown in expression 3 can be rewritten as:

y_{0,j}=x_{0,j} for 0≦j<m

y_{i,j}=aᵢ·x_{i,j}+bᵢ·y_{i-1,j}+cᵢ·x_{i-1,j} for 1≦i<k, 0≦j<m (13)

where x_{0,j}=byte j of data in row 0 of a frame of data X;

x_{i,j}=byte j of data in row i of a frame of data X;

y_{i,j}=byte j of data in row i of a frame of encrypted data Y; and

aᵢ, bᵢ, cᵢ=matrix coefficients for the transformation of row i.

Like the equations in expression 3, the equations in expression 13 can also be expressed as matrix multiplication as shown in equation 14.

$$\qquad ( 14 )$$

$$\begin{matrix}[ \begin{matrix}{y}_{0} \\ {y}_{1} \\ {y}_{2} \\ {y}_{3} \\ … \\ {y}_{k - 1}\end{matrix} ] = Y \\ = A \cdot X \\ = [ \begin{matrix}1 & 0 & 0 & 0 & … & 0 \\ {b}_{1} + {c}_{1} & {a}_{1} & 0 & 0 & … & 0 \\ {b}_{2} \cdot ( {b}_{1} + {c}_{1} ) & {b}_{2} \cdot {a}_{1} + {c}_{2} & {a}_{2} & 0 & … & 0 \\ {b}_{3} \cdot {b}_{2} \cdot ( {b}_{1} + {c}_{1} ) & {b}_{3} \cdot ( {b}_{2} \cdot {a}_{1} + {c}_{2} ) & {b}_{3} \cdot {a}_{2} + {c}_{3} & {a}_{3} & … & 0 \\ … & … & … & … & … & 0 \\ … & … & … & … & … & 0\end{matrix} ] \cdot \\ [ \begin{matrix}{x}_{0} \\ {x}_{1} \\ {x}_{2} \\ {x}_{3} \\ … \\ {x}_{k - 1}\end{matrix} ]\end{matrix}$$

Preferably, the coefficients are derived from at least part of the control data in a manner that makes the values of the coefficients difficult to predict without having access to the control data. In one implementation, the coefficients are derived from the first row x₀ in the selected data from the frame of data. Although the choice of the method or function used to derive the coefficients may have practical significance in affecting the overall security of the encryption process, in principle no particular method is essential. Possible methods are described below. Because the coefficients change in only one dimension, this feature is referred to as one-dimensional dynamic coefficients.

The one-dimensional dynamic coefficient technique can also be used in combination with any of the column and row permutation techniques described above.

### (5) Two-Dimensional Dynamic Coefficients

Another feature alters the transform matrix coefficients in a row-dependent and a column-dependent manner. One way that this may be done is to generate row-dependent coefficients as described above for one-dimensional dynamic coefficients, generate a second set of coefficients d, e and f whose values are column dependent, and multiply the column-dependent coefficients with the row-dependent coefficients. With this feature, the equations shown in expression 3 or expression 13 can be rewritten as:

y_{0,j}=x_{0,j} for 0≦j<m

y_{i,j}=aᵢ·dⱼ·x_{i,j}+bᵢ·eⱼ·y_{i-1,j}+cᵢ·fⱼ·x_{i-1,j} for 1≦i<k, 0≦j<m (15)

where dⱼ, eⱼ, fⱼ=column-dependent matrix coefficients for the transformation of column j.
The transform is invertible if none of the column- and row-dependent coefficients are zero This is a sufficient but not a necessary condition for the transform to be invertible.

The equations in expression 15 can be expressed as a matrix multiplication using a data structure that is referred to herein as a dynamic matrix. The coefficients in a dynamic matrix have values that vary for the arithmetic operations performed to generate encrypted data in different rows and/or columns of the frame of data Y. For example, the coefficients in the dynamic matrix for equation 15 are shown in the following two expressions:

$$\begin{matrix}A \{ 0 , 1 \} = [ \begin{matrix}1 & 0 \\ {b}_{1} \cdot {e}_{j} + {c}_{1} \cdot {f}_{j} & {a}_{1} \cdot {d}_{j} \\ {b}_{2} \cdot {e}_{j} \cdot ( {b}_{1} \cdot {e}_{j} + {c}_{1} \cdot {f}_{j} ) & {b}_{2} \cdot {e}_{j} \cdot {a}_{1} \cdot {d}_{j} + {c}_{2} \cdot {f}_{j} \\ {b}_{3} \cdot {e}_{j} \cdot {b}_{2} \cdot {e}_{j} \cdot ( {b}_{1} \cdot {e}_{j} + {c}_{1} \cdot {f}_{j} ) & {b}_{3} \cdot {e}_{j} \cdot ( {b}_{2} \cdot {e}_{j} \cdot {a}_{1} \cdot {d}_{j} + {c}_{2} \cdot {f}_{j} ) \\ … & … \\ … & …\end{matrix} ] & ( 16 ) \\ A \{ 2 , 3 , … ( k - 1 ) \} = [ \begin{matrix}0 & 0 & … & 0 \\ 0 & 0 & … & 0 \\ {a}_{2} \cdot {d}_{j} & 0 & … & 0 \\ {b}_{3} \cdot {e}_{j} \cdot {a}_{2} \cdot {d}_{j} + {c}_{3} \cdot {f}_{j} & {a}_{3} \cdot {d}_{j} & … & 0 \\ … & … & … & 0 \\ … & … & … & 0\end{matrix} ] & ( 17 )\end{matrix}$$

where A{θ}=coefficients of matrix A used to generate encrypted data in the set of columns {θ} for the frame of data Y.

The transform represented by a dynamic matrix may be implemented in a variety of ways. The transform may be implemented as a matrix multiplication with the frame of data X using a matrix that is selected from a set of matrices {A}. The transform may also be implemented by applying a filter to the frame of data X using a multi-tap filter that is selected from a set of filters. The matrix or filter is selected dynamically on the basis of the row and/or column of the second encrypted data that is being generated in the frame of data Y. More particular mention is made in this disclosure for implementations by matrix multiplications.

For example, the transform represented by expression 15 may be implemented by a matrix multiplication using a matrix that is selected from a set of the two matrices shown in expressions 16 and 17. The appropriate one of these two matrices is selected as a function of the column of the data being generated for the frame of data Y. In this particular example, the matrix shown in expression 16 is selected when generating encrypted data for columns 0 or 1 and the matrix shown in expression 17 is selected when generating encrypted data for all other columns in the frame of data Y.

Preferably, the row-dependent coefficients and the column-dependent coefficients are derived from at least part of the control data in a manner that makes the values of the coefficients difficult to predict without having access to the control data. In one implementation, the coefficients are derived from the first row x₀ in the selected data from the frame of data. Although the choice of the method or function used to derive the coefficients may have practical significance in affecting the overall security of the encryption process, in principle no particular method is essential. Possible methods are described below. Because the coefficients of the result matrix change in two dimensions, this feature is referred to as two-dimensional dynamic coefficients.

The two-dimensional dynamic coefficient technique can also be used in combination with any of the column and row permutation techniques described above.

### (6) Zero-Bytes Prevention

If all of the bytes in one or more rows of data in the frame of data X have zero values or have the same value, then the level of security provided by the second encryption process may be impaired. The probability that this situation will occur can be reduced to essentially zero by adding a non-zero term to the transform equations. This feature is referred to herein as a zero-byte prevention technique because repeating values are more likely to occur for zero that for any other value. Two different ways are shown in equations 18 and 19 that may be used to implement a zero-byte prevention technique for the transform of expression 15:

y_{i,j}=aᵢ·dⱼ·x_{i,j}+bᵢ·eⱼ·y_{i-1,j}+cᵢ·fⱼ·x_{i-1,j}+gᵢ·hⱼ for 1≦i<k, 0≦j<m (18)

y_{i,j}=aᵢ·dⱼ·(x_{i,j}+gᵢ·hⱼ)+bᵢ·eⱼ·y_{i-1,j}+cᵢ·fⱼ·x_{i-1,j} for 1≦i<k, 0≦j<m (19)

where gᵢ=row-dependent non-zero coefficient; and

hⱼ=column-dependent non-zero coefficient.

More non-zero terms can be added if desired. The addition of only one non-zero term represents a balance between the amount of reduction in probability that the transform is applied to a row of bytes with the same value and the computational resources required to implement the technique.

The two zero-byte prevention techniques shown above are equivalent mathematically to an operation that adds a zero-byte prevention dynamic matrix B to the transform as follows:

Y=A·X+B (20)

where the dynamic matrix B is:

$$\begin{matrix}B \{ j \} = [ \begin{matrix}1 \\ {g}_{1} {h}_{j} \\ {b}_{2} {e}_{j} \cdot {g}_{1} {h}_{j} + {g}_{2} {h}_{j} \\ {b}_{3} {e}_{i} \cdot ( {b}_{2} {e}_{j} \cdot {g}_{1} {h}_{j} + {g}_{2} {h}_{j} ) + {g}_{3} {h}_{j} \\ …\end{matrix} ] for equation 18 ; \\ and & ( 21 ) \\ B \{ j \} = [ \begin{matrix}1 \\ {a}_{1} {d}_{j} {g}_{1} {h}_{j} \\ {b}_{2} {e}_{j} \cdot {a}_{1} {d}_{j} {g}_{1} {h}_{j} + {a}_{2} {d}_{j} {g}_{2} {h}_{j} \\ {b}_{3} {e}_{i} \cdot ( {b}_{2} {e}_{j} \cdot {a}_{1} {d}_{j} {g}_{1} {h}_{j} + {a}_{2} {d}_{j} {g}_{2} {h}_{j} ) + {a}_{3} {d}_{j} {g}_{3} {h}_{j} \\ …\end{matrix} ] \\ for equation 19. & ( 22 )\end{matrix}$$

where B{j}=coefficients of matrix B in column j.

Although the expression for the values of the coefficients in the matrix A and the zero-prevention dynamic matrix B remains the same for all rows and columns, the actual values of the coefficients vary from row to row and from column to column because these values are derived from the two-dimensional dynamic coefficient technique discussed above.

If desired, the zero-byte prevention technique can use a static matrix such as that described above for the one-dimensional dynamic coefficient technique by setting the column-dependent coefficients d, e and f equal to 1. The zero-byte prevention technique can be used with the basic transform by setting the coefficients a, b and c to values that do not vary from row to row.

### (7) Initialization Vectors

Preferred implementations of permutation and dynamic coefficient techniques discussed above control the permutations and modifications of coefficients in response to data that is obtained or derived from information in the control data. In one implementation, data in the first row x₀ of the frame is used. If the data that is used is constant or predictable for different frames of data, then the resulting permutation orders and coefficient modifications may also be predictable, which would reduce the level of security provided by the second encryption process.

This situation can be essentially eliminated by using a feature that introduces an unpredictable number or initialization vector (IV) into the methods used to obtain the permutation order or the dynamic coefficients. Both the IV and other data such as the first row of data x₀ are used. The IV is associated with the specified material in preferred implementations but it can be associated with some other element such as an intended recipient. Any IV that is used is included with the control data and is encrypted by the first encryption process.

The IV can be changed occasionally when encrypting a sequence of frames. If the existence of a new value for the IV cannot be predicted or determined from other data already in the signal, the change in the IV can be indicated by some additional data that is included with or associated with the first encrypted data or the second encrypted data. If desired, a different IV can be used for each frame of data. The new value may be predictable or unpredictable. One way that a predictable value may be generated is to modify the IV from one frame to the next in a predictable or a specified manner. For example, the IV can be incremented by a fixed amount for each successive frame or it can be incremented by an amount that is obtained from the control data.

Although the choice of the method or function used to obtain an IV may have practical significance in affecting the overall security of the encryption process, in principle no particular method is essential. Possible methods are described below.

### b) Initialization

Preferred implementations that use column and row permutation and dynamic coefficients control the order of the permuted rows and columns and the values of dynamic coefficients in response to initialization data that is derived from selected data in a frame of data such as from the first row of data x₀. The security of the second encryption process can be enhanced if the value of every bit of the initialization data depends on the value of every bit in the selected data. This may be done by using a block cipher with some chaining mechanism such as cipher block chaining (CBC). This mode of encryption performs an exclusive-OR (XOR) between a current block of data with the encrypted result of a previous block of data before encrypting the current block.

In one implementation, the first row of data x₀ is divided into blocks of data P₀, P₁, P₂, . . . P_{S}. A block cipher is applied to each block in sequence. The blocks of encrypted data C₀, C₁, C₂, . . . C_{S} that are obtained from the block cipher represent a pseudo-random stream of binary data that can be used to calculate an IV or initialize the permutation and dynamic coefficient techniques discussed above. If initialization requires a bit stream that is longer than the length of the row x₀, the cipher can wrap around to the beginning of the row and continue its processing by using the encrypted block C_{S} from the end of the row to XOR the first data block P₀ prior to encrypting it again. The initial encryption of the first data block P₀ can use an IV, an encryption key or both that are derived from all or any part of the first row of data x₀. Many variations are possible. No particular technique is critical.

If desired, the cipher can make an initial pass over all of the data blocks P₀, P₁, P₂, . . . P_{S} in the first row x₀ before generating the initialization data. In one implementation, the initial set of encrypted data blocks C₀, C₁, C₂, . . . C_{S} obtained from the initial pass is used in place of the first row of data x₀.

Special care is needed for the dynamic coefficient techniques because the resulting transform may not be invertible if certain coefficients are zero. This problem can be avoided by omitting all zero-valued bytes from the initialization data. One way to implement this technique is a procedure that examines each byte in the pseudo-random stream and inserts that byte into the initialization data only if it has a non-zero value.

The permuted order used by the column and row permutation techniques can be generated in many ways. Preferably, the permuted order is based on information derived from the first row of data x₀. One way that is efficient and statistically unbiased generates a permuted order by generating pseudo-random numbers within a monotonically decreasing range of values to specify a rearrangement in the order of a sequence of numbers.

For example, a permuted order of columns may be generated by a process that constructs an array CX of column numbers and rearranges the order of the numbers in some random fashion. The array has m elements numbered from 0 to m−1 and is initialized so that each array element CX[i] records the number i. The process iteratively derives a series of pseudo-random numbers N₁, N₂, . . . Nₘ from the first row of data x₀ using some technique such as the CBC technique mentioned above. The number N₁ generated during the first iteration has a value that is restricted to be within the range from 0 up to and including m−1. The number for each successive iteration is restricted to be within a steadily decreasing range. If the symbol R represents the iteration number, the pseudo-random number N_{R} from the R-th iteration is restricted to be within a range that may be expressed as 0≦N_{R}≦m−R. For example, the range for the number N₁ generated by the first iteration is 0≦N₁≦m−1 and the range for number Nₘ generated by the last or m-th iteration is 0≦Nₘ≦0. If desired, the number Nₘ for the last iteration can be set equal to zero without deriving a pseudo-random number. The permuted order is generated by rearranging elements in the array CX. For each iteration, the value recorded in the array element CX[m−R] is exchanged with the value recorded in the array element CX[N_{R}]. Upon completion of the last iteration, the sequence of array elements CX[i] for i=0 to m−1 record the column numbers in a permuted order that is derived from the first row of data x₀.

The same technique may be used to generate a permuted order of rows in an array of elements RX[i]. The pseudo-random numbers N_{R} are generated for iterations that run from R=k−1 to 1 with values that are restricted within a range that may be expressed as 1≦N_{R}≦k−R. Upon completion of the last iteration, the sequence of array elements RX[i] for i=1 to k−1 record the row numbers in a permuted order that is derived from the first row of data x₀.

Initialization vectors can be obtained from essentially any desired source such as a pseudo-random stream of numbers generated by a pseudo-random number generator. One simple procedure uses the beginning of the pseudo-random stream as the IV. If the IV is 128 bits long, for example, it can be obtained from the first 128 bits of the pseudo-random stream.

The specific implementations and procedures mentioned here are only examples of ways initialization may be performed. Essentially any technique that can generate pseudo-random data may be used.

### c) Simplified Enhanced Transform

A particular transform with a dynamic matrix referred to herein as a Simplified Enhanced Transform (SET) will now be described. The SET is a variation of the basic transform enhanced by features that permute the matrix coefficients and randomize the non-selected data to be encrypted using a process initialized by a pseudo-random stream of binary data derived from the first data row x₀ as explained above. The SET is efficient and provides a good level of security for many applications.

The SET may be represented as shown in expression 23:

y_{0,j}=x′_{0,j} for 0≦j<m

y_{i,j}=a′_{i,j}·d′_{i,j}·x′_{i,j} for 1≦i<k, 0≦j<m (23)

where x′_{0,j}=pseudo-random stream of binary data derived from data row x₀; (24a)

a′_{i,j}=a_{i,R(i,j,k)}=row-dependent column-shifted matrix coefficient; (24b)

d′_{i,j}=d_{S(i,j,m),j}=column-dependent row-shifted matrix coefficient; and (24c)

x′_{i,j}=x_{i,j}+x′_{P(i,j,m),j}=randomized non-selected data to be encrypted. (24d)

Preferably, the pseudo-random stream of binary data denoted as x′_{0,i} is derived from the initial pass of a CBC process applied to the first data row x₀. The matrix coefficients a′ and d′ should have non-zero values.

The notation R(i,j,k) represents a function that permutes the order of the a coefficients. The notation S(i,j,m) represents a function that permutes the order of the d coefficients. The notation P(i,j,m) represents a function that permutes the order of blocks in the first data row x₀.

The permutation functions mentioned above may be implemented as shown in the following expressions:

R(i,j,k)=(i−ra(j)) mod k (25)

S(i,j,m)=(j−rd(i)) mod m (26)

P(i,j,m)=(j−rx(i)) mod m (27)

where ra(j)=pseudo-random mapping function for integers between 0 and k−1;

rd(i)=pseudo-random mapping function for integers between 0 and m−1;

rx(i)=pseudo-random mapping function for integers between 0 and m−1; and

mod n=modulus operator returning non-negative numbers between 0 and n−1.

In a preferred implementation, the value for each mapping function ra(j), rd(i) and rx(i) is calculated once for each frame of data. The mapping functions may be implemented from numbers generated by a pseudo-random number generator or by the CBC initialization process mentioned above.

Preferably, the mapping functions ra(j), rd(i) and rx(i) are implemented as permutation functions that generate each integer in the output ranges 0 to k−1 and 0 to m−1 once and only once for each frame of non-selected data. If these mapping functions are implemented as permutation functions, then the coefficients a′ are row-dependent column-permuted matrix coefficients and the coefficients d′ are column-dependent row-permuted matrix coefficients.

The output ranges for the pseudo-random mapping functions that are mentioned above are generally preferred. Different output ranges may be used but the level of the security provided by the resulting SET may be impaired.

The plus (+) operator in expression 24d represents an XOR operation between a permutation of the pseudo-random stream of binary data derived from the first data row x₀ and blocks of non-selected data in the remaining rows of data. The permutation may be implemented by a circular shift that rotates the pseudo-random stream by a number of bytes or bits that changes for each row of the non-selected data. If desired, some or all required amounts of rotation can be pre-computed and stored for use during the encryption process.

If desired, an alternate SET may be used to implement the second encryption process. The alternate SET may be derived from the SET by transposing the coefficients a′ and d′ shown in the equations above, swapping row and column vectors, and interchanging references to rows and columns.

### d) Cipher Keys

Some of the techniques described above may use a second encryption process that is responsive to both an encryption key and an IV. The IV itself may be considered a type of encryption key. If desired, the techniques described above for generation of an IV or other initialization data may be used to generate an encryption key. An encryption key that is obtained in this manner is a material-oriented key. It may be used to encrypt all or at least part of the remaining data in a frame of data. The IV is encrypted by the first encryption process and included in the first encrypted data. One advantage of this approach is,that it provides a simple method to distribute the data that the receiver 15 needs to derive the decryption key for the second decryption process.

If desired, the same encryption algorithm may be used for the first and second encryption processes and the same decryption process may be used for the first and second decryption processes. Essentially any algorithms may be used but symmetric-key algorithms like AES or DES are convenient choices because key distribution is simplified. If an asymmetric-key algorithm is used for the first encryption process, a method is needed to distribute the appropriate decryption key. In one distribution method, the processor 10 derives the appropriate decryption key and includes it in the control data that is encrypted by the first encryption process.

### E. Decryption Processes

### 1. Overview

The first and second decryption processes used to decrypt the first and second encrypted data may be performed in a variety of ways but they should be inverse processes of the respective first and second encryption processes used to generate the encrypted data. Examples of processes that are suitable for decrypting data that is generated by the basic transform described above are discussed in the following paragraphs.

### 2. Basic Implementation

The second decryption process may be implemented by any suitable transform that is inverse to the transform used to generate the second encrypted data. Examples are shown above in equation 2. The basic inverse transform shown above in expression 6 is suitable for the receiver 15 for use in systems that employ the basic transform of expression 3.

### 3. Alternative Implementations

If the second encryption process uses the basic transform of expression 3 and incorporates any of the additional features discussed above, corresponding inverse features discussed below should be used with the basic inverse transform of expression 6.

Implementations of the basic inverse transform with and without additional features discussed above correspond to an arithmetic process that multiplies a matrix A⁻¹ of coefficients by a frame of the data Y to be decrypted. An inspection of the equations shown in expression 6 reveals that the arithmetic operations for each column of the frame of data Y or the frame of data X are performed independently of the arithmetic operations for other columns. The level of security can be improved by using one or more features discussed below.

If the second encryption process uses the alternate basic transform or some variation with additional features mentioned above, the decryption process should use the alternate basic inverse transform or an appropriate variation of it. An implementation of the appropriate inverse transform corresponds to an arithmetic process that multiplies a frame of the data Y to be decrypted by a matrix A⁻¹ of coefficients. The arithmetic operations for each row of the frame of data Y or the frame of data X are performed independently of the arithmetic operations for other rows. If the second encryption process also incorporates appropriate variations of the additional features discussed above, corresponding inverse features should be incorporated into the decryption process. The corresponding inverse features may be derived from the following discussion by interchanging references to rows and columns and making other changes as explained above.

An application of the inverse transform is generally referred to in the following discussion in terms of matrix operations or various arithmetic operations with a matrix of coefficients arranged in rows and columns. Just as for the discussion of the encryption process, these references are a convenient way to describe the alternative implementations and are not intended to imply any particular way in which this inverse transform must be implemented. Other methods of implementation are possible such as the application of one or more multi-tap filters to the frame of data Y to be decrypted.

### a) Additional Inverse Features

Features that are complementary to the additional features discussed above, referred to herein as inverse features, may be realized is by performing various operations in addition to an application of the basic inverse transform as explained below.

### (1) Column and Row Permutations

Some inverse features rearrange the columns, rows or both columns and rows of the inverse matrix A⁻¹, the encrypted data Y or the decrypted data X in a manner that is the inverse of that done in the second encryption process. This is referred to as inverse permutation. If a permutation was performed before application of the transform matrix, then a corresponding inverse permutation is performed after application of the inverse transform matrix. If a permutation was performed after application of the transform matrix, then a corresponding inverse permutation is performed before application of the inverse transform matrix.

### (2) Dynamic Coefficients

Other inverse features modify the coefficients of the inverse matrix so that it remains an inverse of the matrix used to encrypt the data. The coefficients may be adapted according to either the one-dimensional or two-dimensional dynamic coefficient techniques discussed above.

An inverse transform that has two-dimensional dynamic coefficients may be implemented as a matrix multiplication with a dynamic matrix in which the appropriate matrix is selected from a set of inverse matrices {A⁻¹}. Each matrix in the set of inverse matrices is an inverse of a respective matrix in a set of matrices {A} that represent the second encryption transform. If desired, the inverse transform can also be implemented by application of a set of multi-tape filters in which each filter is inverse to a respective filter in a set of filters that represent the second encryption transform.

### (3) Zero-Byte Prevention

Another inverse feature is the inverse of the zero-byte prevention technique discussed above. The inverse technique is equivalent mathematically to an operation that subtracts the zero-prevention dynamic matrix B from the inverse transform as follows:

X=A⁻¹·(Y−B)=A⁻¹·Y−A⁻¹−B=A⁻¹·Y−B⁻¹ (28)

where B⁻¹ denotes the inverse zero-prevention dynamic matrix.

The dynamic matrix B and its inverse B⁻¹ depend on the specific implementation of the zero-byte prevention technique that is used as described above and shown in equations 21 and 22. If desired, the inverse dynamic matrix B⁻¹ can be calculated as follows:

B⁻¹=A⁻¹·B (29)

### (4) Initialization Vectors

Preferred implementations of permutation and dynamic coefficient techniques discussed above control the permutations and modifications of coefficients in response to data that is obtained or derived from information in the control data. This control data is encrypted by the first encryption process and included in the first encrypted data. The inverse permutation and inverse dynamic coefficient techniques control their operation in response to the same data, which is obtained by decrypting the first encrypted data. Any IV that is needed is included in the first encrypted data.

### b) Initialization

Implementations of inverse features in the second decryption process can initialize their operation from the same initialization data that was used by the complementary features in the second encryption process. This initialization data may be derived in the same way it was derived for encryption. All required data for this derivation can be included in the first encrypted data.

### c) Inverse Simplified Enhanced Transform

If the SET is used to perform the second encryption process, the second decryption process is implemented by an inverse transform referred to herein as an Inverse Simplified Enhanced Transform (ISET). The ISET is a variation of the basic inverse transform enhanced by features that permute the matrix coefficients and de-randomize the non-selected data.

The ISET may be represented as shown in expression 30:

$$\begin{matrix}{x}_{0 , j}^{′} = {y}_{0 , j} & for 0 \leq j < m \\ {x}_{i , j}^{′} = \frac{{y}_{i , j}}{{a}_{i , j}^{′} \cdot {d}_{i , j}^{′}} & for 1 \leq i < k , 0 \leq j < m\end{matrix} \qquad ( 30 )$$

where x_{i,j}=x′_{i,j}+x′_{P(i,j,m)}=non-selected data after decryption. (31)

The plus (+) operator in expression 31 represents an XOR operation between a permutation of the pseudo-random stream of binary data derived from the first data row x₀ and encrypted blocks of non-selected data in the remaining rows of data. The permutation may be implemented by a circular shift that rotates the pseudo-random stream by a number of bytes or bits that changes for each row of the non-selected data. If desired, some or all required amounts of rotation can be pre-computed and stored for use during the decryption process.

If the second encryption process uses the alternate SET discussed above, a corresponding alternate ISET should be used for the second decryption process. The alternate ISET may be derived from the ISET by transposing the matrix represented by the matrix coefficients shown in expression 30, swapping row and column vectors, and interchanging references to rows and columns.

### d) Cipher Keys

The receiver 15 may obtain all needed decryption keys in essentially any manner that may be desired. In preferred implementations, the second decryption key is obtained from or derived from control data that is recovered by decrypting the first encrypted data. The first decryption key that is needed to decrypt the first encrypted data may be distributed in any manner desired. For example, if the first decryption key is the private key of an intended recipient in a public-key/private-key pair that is associated with that recipient, the public key would be used to generate the first encrypted data and the private key could have been created by the entity that encrypted the data and distributed to the recipient by some secure method apart from the distribution of the first encrypted data. Conversely, the key pair could have been created by the recipient and the public key provided to the entity that encrypts the data. This latter method has the advantage that no secure channel is needed to distribute the public key.

### F. Implementation

Devices that incorporate various aspects of the present invention may be implemented in a variety of ways including software for execution by a computer or some other device that includes more specialized components such as digital signal processor circuitry coupled to components similar to those found in a general-purpose computer. FIG. 8 is a schematic block diagram of a device 70 that may be used to implement aspects of the present invention. The processor 72 provides computing resources. RAM 73 is system random access memory (RAM) used by the processor 72 for processing. ROM 74 represents some form of persistent storage such as read only memory (ROM) for storing programs needed to operate the device 70 and possibly for carrying out various aspects of the present invention. I/O control 75 represents interface circuitry to receive and transmit signals by way of the communication channels 76, 77. In the embodiment shown, all major system components connect to the bus 71, which may represent more than one physical or logical bus; however, a bus architecture is not required to implement the present invention.

In embodiments implemented by a general purpose computer system, additional components may be included for interfacing to devices such as a keyboard or mouse and a display, and for controlling a storage device 78 having a storage medium such as magnetic tape or disk, or an optical medium. The storage medium may be used to record programs of instructions for operating systems, utilities and applications, and may include programs that implement various aspects of the present invention.

The functions required to practice aspects of the present invention can be performed by components implemented in a wide variety of ways including discrete logic components, integrated circuits, one or more ASICs and/or program-controlled processors. The manner in which these components are implemented is not important to the present invention.

Software implementations of the present invention may be conveyed by a variety of machine readable media such as baseband or modulated communication paths throughout the spectrum including from supersonic to ultraviolet frequencies, or storage media that convey information using essentially any recording technology including magnetic tape, cards or disk, optical cards or disc, and detectable markings on media including paper.

1 to 44. (canceled)

45. An encoding method that comprises:
receiving one or more signals conveying data that either identifies or conveys specified material representing stimuli intended for human perception;
obtaining a first encryption key;
obtaining control data that comprises selected data in a frame of data and information that represents a second encryption key that is associated with the specified material and differs from the first encryption key, wherein the selected data represents at least a portion of the specified material and is less than all data in the frame of data;
applying a first encryption process to the control data to generate first encrypted data, wherein the first encryption process is responsive to the first encryption key;
applying a second encryption process to non-selected data in the frame of data that is not included in the selected data to generate second encrypted data, wherein the second encryption process is responsive to the second encryption key, and wherein the non-selected data comprise symbols, the second encryption process comprises arithmetic operations that multiply the symbols of the non-selected data by coefficients in which the symbols are arranged in rows and columns and arithmetic operations for each column are performed independently of arithmetic operations for other columns or arithmetic operations for each row are performed independently of arithmetic operations for other rows; and
assembling the first encrypted data into a first encoded signal for delivery to a recipient for use in obtaining a decryption key for decrypting the second encrypted data.

46. The encoding method of claim 45, wherein the selected data comprises the information that represents the second encryption key.

47. The encoding method of claim 46 that comprises assembling the second encrypted data into the first encoded signal.

48. The encoding method of claim 46 that comprises assembling the second encrypted data into a second encoded signal.

49. The encoding method of claim 46, wherein the second encryption process is applied incrementally to portions of the non-selected data to generate the second encrypted data in a progressive manner.

50. The encoding method of claim 46,
wherein the arithmetic operations multiply the rows and columns of the symbols by coefficients in a dynamic matrix; and
the dynamic matrix is implemented by a process that selects a matrix of coefficients from a set of matrices in response to the row or column of the symbols being multiplied.

51. The encoding method of claim 50, wherein the coefficients are arranged in a triangular array of coefficients with zero values such that the multiplying is equivalent to an iterative application of one or more filters to the rows or columns of the symbols and the second encryption process further comprises:
a permutation of the columns in response to the control data, wherein the permutation of the columns varies across the rows;
a permutation of the rows in response to the control data, wherein the permutation of the rows varies across the columns; and
wherein the coefficients for the taps of the one or more filters are varied for each row in response to the control data.

52. The encoding method of claim 51, wherein coefficients for the taps of the one or more filters are also varied for each column in response to the control data.

53. The encoding method of claim 46, wherein the first encryption key is associated with an intended recipient of the specified material.

54. A decoding method that comprises:
receiving a first encoded signal conveying first encrypted data representing control data that comprises selected data in a frame of data, wherein the selected data represents at least a portion of specified material representing stimuli intended for human perception, and wherein the selected data is less than all data in the frame of data;
applying a first decryption process to the first encrypted data to recover the control data, wherein the first decryption process is responsive to a first decryption key, and wherein the control data comprises information that represents a second decryption key that is associated with the specified material and differs from the first decryption key;
applying a second decryption process to second encrypted data to recover non-selected data in the frame of data that is not included in the selected data, wherein the second decryption process is responsive to the second decryption key, wherein the second decryption process comprises arithmetic operations that multiply the second encrypted data by coefficients in which the second encrypted data is arranged in rows and columns and arithmetic operations for each column are performed independently of arithmetic operations for other columns or arithmetic operations for each row are performed independently of arithmetic operations for other rows; and
generating a signal representing at least a portion of the specified material by assembling the selected data and the non-selected data into a frame of data.

55. The decoding method of claim 54, wherein the selected data comprises the information that represents the second decryption key.

56. The decoding method of claim 55 that comprises obtaining the second encrypted data from the first encoded signal.

57. The decoding method of claim 55 that comprises obtaining the second encrypted data from a second encoded signal.

58. The decoding method of claim 55, wherein the second decryption process is applied incrementally to portions of the second encrypted data to generate the non-selected data in a progressive manner.

59. The decoding method of claim 55,
wherein the arithmetic operations multiply the rows and columns of the second encrypted data by coefficients in a dynamic matrix; and
the dynamic matrix is implemented by a process that selects a matrix of coefficients from a set of matrices in response to the row or column of the data being multiplied.

60. The decoding method of claim 59, wherein the second decryption process further comprises a permutation of the columns in response to the control data, wherein the permutation of the columns varies across the rows.

61. The decoding method of claim 59, wherein the second decryption process further comprises a permutation of the rows in response to the control data, wherein the permutation of the rows varies across the columns.

62. The decoding method of claim 59, wherein the coefficients are arranged in a triangular array of coefficients with zero values such that the multiplying is equivalent to an iterative application of one or more filters to the rows or columns of the encrypted data.

63. The decoding method of claim 62, wherein coefficients for the taps of the one or more filters are varied for each row in response to the control data.

64. The decoding method of claim 62, wherein coefficients for the taps of the one or more filters are varied for each row and column in response to the control data.

65. The decoding method of claim 55, wherein the first decryption key is associated with an intended recipient of the specified material.

66. A storage medium conveying a program of instructions that is executable by a device to perform a decoding method that comprises:
receiving a first encoded signal conveying first encrypted data representing control data that comprises selected data in a frame of data, wherein the selected data represents at least a portion of specified material representing stimuli intended for human perception, and wherein the selected data is less than all data in the frame of data;
applying a first decryption process to the first encrypted data to recover the control data, wherein the first decryption process is responsive to a first decryption key, and wherein the control data comprises information that represents a second decryption key that is associated with the specified material and differs from the first decryption key;
applying a second decryption process to second encrypted data to recover non-selected data in the frame of data that is not included in the selected data, wherein the second decryption process is responsive to the second decryption key, wherein the second decryption process comprises arithmetic operations that multiply the second encrypted data by coefficients in which the second encrypted data is arranged in rows and columns and arithmetic operations for each column are performed independently of arithmetic operations for other columns or arithmetic operations for each row are performed independently of arithmetic operations for other rows; and
generating a signal representing at least a portion of the specified material by assembling the selected data and the non-selected data into a frame of data.

67. The medium of claim 66, wherein the selected data comprises the information that represents the second decryption key.

68. The medium of claim 67, wherein the method comprises obtaining the second encrypted data from the first encoded signal.

69. The medium of claim 67, wherein the method comprises obtaining the second encrypted data from a second encoded signal.

70. The medium of claim 67, wherein the second decryption process is applied incrementally to portions of the second encrypted data to generate the non-selected data in a progressive manner.

71. The medium of claim 67,
wherein the arithmetic operations multiply the rows and columns of the second encrypted data by coefficients in a dynamic matrix; and
the dynamic matrix is implemented by a process that selects a matrix of coefficients from a set of matrices in response to the row or column of the data being multiplied.

72. The medium of claim 71, wherein the second decryption process further comprises a permutation of the columns in response to the control data, wherein the permutation of the columns varies across the rows.

73. The medium of claim 71, wherein the second decryption process further comprises a permutation of the rows in response to the control data, wherein the permutation of the rows varies across the columns.

74. The medium of claim 71, wherein the coefficients are arranged in a triangular array of coefficients with zero values such that the multiplying is equivalent to an iterative application of one or more filters to the rows or columns of the encrypted data.

75. The medium of claim 74, wherein coefficients for the taps of the one or more filters are varied for each row in response to the control data.

76. The medium of claim 74, wherein coefficients for the taps of the one or more filters are varied for each row and column in response to the control data.

77. The medium of claim 67, wherein the first decryption key is associated with an intended recipient of the specified material.
